(19) United States
(12) Patent Application Publication
(10) Pub. No.: US 2017/0082133 A1
(43) Pub. Date: Mar. 23, 2017

(54) DETACHABLE SLEEVE AND FASTENER ASSEMBLY INCLUDING THE DETACHABLE SLEEVE

(71) Applicants: Steven G. Grosick, Oakdale, PA (US); William D. Myers, Jefferson Hills, PA (US)

(72) Inventors: Steven G. Grosick, Oakdale, PA (US); William D. Myers, Jefferson Hills, PA (US)

(73) Assignee: Superbolt, Inc., Carnegie, PA (US)

(21) Appl. No.: 15/267,601

(22) Filed: Sep. 16, 2016

Related U.S. Application Data
(60) Provisional application No. 62/219,869, filed on Sep. 17, 2015.

(51) Int. Cl. F16B 37/14; F16B 43/00

(52) U.S. Cl. CPC F16B 37/14; F16B 43/00

(57) ABSTRACT

A sleeve for retaining one or more washers in abutting relation to a face of a fastening means is disclosed. The sleeve includes a main body having a top portion which is angled at a top end to form a ridge, and a bottom portion which includes an annular lip that extends radially inward from an inner surface thereof. The ridge is designed to rest against a flange of the fastening means, and the annular lip is designed to retain the washer in abutting relation to the face of the fastening means. The sleeve partially surrounds and loosely holds the washer and the fastening means together, and becomes detached from the fastening means and the washer after installation of the fastening means. Also disclosed is a fastener assembly including the sleeve, a fastening means, and a washer, and methods of manufacturing the fastener assembly.

### TECHNICAL FIELD OF THE INVENTION

The present application claims the benefit under 35 U.S.C. §119(e) of prior U.S. Provisional Application No. 62/219,869 filed Sep. 17, 2015, having the title “Detachable Sleeve,” the disclosure of which is incorporated herein by reference in its entirety.

This invention pertains generally to a fastener assembly which includes a detachable sleeve that may encase a fastening means and associated components. More specifically, the invention pertains to a detachable sleeve that may be used to form a fastener assembly comprising the sleeve, a fastening means, and associated washers that may be packaged, shipped, and installed as a one piece unit, wherein, after installation, the sleeve is detached.

### BACKGROUND OF THE INVENTION

When using nuts and bolts for fastening or mounting, other components such as washers are often included to provide for enhanced securement. When installing such a mounting element, it can be awkward to have several loose and separate components that must be installed together, especially for installations in places that are difficult to access. Furthermore, certain components, such as washers of a unique design intended for special mounting purposes, may need to be fitted in a certain order and/or in an exact orientation. In such a case, it is important that these specialized components are maintained together with the mounting element in that specific order and/or orientation.

From the point of view of handling, it is also a disadvantage to have to keep track of and manage several loose components. Beyond the need to maintain the various components of the mounting element together, it is often necessary to track that all of the components are actually fitted by the person performing the task. This not only affects the functionality of the fastening means, but also the safety of the fastening and/or the components joined by the fastening.

The method of holding a washer and nut together using an inside flange on the nut is previously known, such as the flanged nuts described in U.S. Pat. Nos. 4,362,449 and 5,203,656. It is also known to have a lower washer with a high outside flange which hooks onto the nut, such as described in U.S. Pat. Nos. 4,986,712 and 5,688,091. Both of these concepts are also described in U.S. Pat. No. 4,969,788. For all, however, the method of manufacture is more complicated and is thus economically disadvantageous. Since mounting elements are manufactured in large volumes, each increase in manufacturing capacity is of great importance.

Containment means or cap members arranged to keep together a fastening means such as a nut or bolt, and a pair of washers have also been described. See for example the disclosures of U.S. Pat. Nos. 4,969,788, 6,592,314 and 6,896,465. In each case, however, the containment means is not designed to be removed after installation of the nut and washers, and is specifically configured to accommodate only a single nut and washer design. For example, U.S. Pat. No. 6,896,465 discloses a combination including a containment means, a nut, and a washer pair, wherein one of the washers has an extension or shoulder that provides a ledge for an end of the containment means to attach. This ledge is necessary to maintain an air space between the containment means and the surface on which the fastener is installed since the containment means remains in place during and after installation.

Thus, what is needed is a sleeve or retainer in an advantageous combination with a fastening means and washer(s), wherein the sleeve at least partially encapsulates and secures the fastening means and washer(s), and becomes detached, or is removable, upon installation of the fastening means and washer(s). Further, there is a need in the art for a sleeve which may accommodate a broader range of fastening means and associated washer(s).

### SUMMARY OF THE INVENTION

The presently disclosed invention provides a sleeve for retaining a washer in abutting relation to a face of a fastening means. The sleeve comprises a main body which includes a top portion which is angled at a top end to form a ridge; and a bottom portion defined by a bottom end of the main body and an annular lip that extends radially inward from an inner surface of the main body and is positioned at a distance from the bottom end of the main body. The ridge of the top portion is configured to rest against a flange of the fastening means, and the annular lip of the bottom portion is configured to removeably retain the washer in abutting relation to the face of the fastening means.

The presently disclosed invention also provides a fastener assembly comprising a fastening means having a face and a central mounting feature intersecting the face; a washer abutting the face of the fastening means, the washer having a central bore aligned with the central mounting feature of the fastening means; and the sleeve removeably attachable about the fastening means and the washer. The central mounting feature of the fastening means may be a central bore, such as for a nut, or may be a threaded shank, such as for a bolt or screw.

The present invention also provides a method of manufacture of the fastener assembly.

### BRIEF DESCRIPTION OF THE DRAWINGS

Aspects, features, benefits and advantages of the embodiments herein will be apparent with regard to the following description, appended claims, and accompanying drawings.

In the following figures, like numerals represent like features in the various views. It is to be noted that features and components in these drawings, illustrating the views of embodiments of the present invention, unless stated to be otherwise, are not necessarily drawn to scale.

FIG. 1 illustrates a top perspective view of a fastener assembly in accordance with certain aspects of the present invention;

FIG. 2 illustrates a bottom perspective view of the fastener assembly shown in FIG. 1;

FIG. 3 illustrates an exploded view of the fastener assembly shown in FIG. 1;

FIG. 4 illustrates a cross-sectional view taken along line 4-4 of the fastener assembly shown in FIG. 1;

FIG. 5 illustrates a top elevation view of a sleeve in accordance with certain aspects of the present invention;

FIG. 6 illustrates a cross-sectional view taken along line 6-6 of the sleeve shown in FIG. 5;

FIG. 7 illustrates a close-up view of detail A from FIG. 6, showing the annular lip of the sleeve; and

FIG. 8 illustrates a close-up view of detail B from FIG. 6, showing the angled top end of the serrated fingers of the sleeve.

### DETAILED DESCRIPTION

In the following description, the present invention is set forth in the context of various alternative embodiments and implementations involving a detachable sleeve which may be used to form a coupled assembly of a fastening means, such as a nut or bolt or screw, and a washer. The detachable sleeve ensures that the fastening means and washer can be packaged, shipped and installed as a one piece unit. That is, the fastening means and washer(s) are at least partially encased in the detachable sleeve. On installation, the detachable sleeve can be removed manually or automatically by an assembly action, and can then be discarded. As a byproduct of the installation, the detachable sleeve can be counted and used as a secondary quality check by the end user to ensure a specified number of assemblies have been installed.

Thus, the present invention provides a controlling mechanism to ensure proper installation of fasteners which include washers, and a quality check to ensure that all parts of and a certain number of fasteners have been installed. Beyond these improvements, the present invention makes for an easier installation of fasteners in hard to reach locations, and provides a generic or universal sleeve product that may be configured for use with a wide variety of fastener types and sizes.

Various aspects of the coupled assembly may be illustrated by describing components that are coupled, attached, and/or joined together. As used herein, the terms “coupled”, “attached”, and/or “joined” are interchangeably used to indicate either a direct connection between two components or, where appropriate, an indirect connection to one another through intervening or intermediate components. In contrast, when a component is referred to as being “directly coupled”, “directly attached”, and/or “directly joined” to another component, there are no intervening elements shown in said examples.

Various aspects of the coupled assembly may be illustrated with reference to one or more exemplary implementations. As used herein, the term “exemplary” means “serving as an example, instance, or illustration,” and should not necessarily be construed as preferred or advantageous over other variations of the devices, systems, or methods disclosed herein. “Optional” or “optionally” means that the subsequently described event or circumstance may or may not occur, and that the description includes instances where the event occurs and instances where it does not. In addition, the word “comprising” as used herein means “including, but not limited to”.

Furthermore, throughout the specification, reference to “one embodiment,” “an embodiment,” or “some embodiments” means that a particular described feature, structure, or characteristic is included in at least one embodiment. Thus, appearances of the phrases “in one embodiment,” “in an embodiment,” or “in some embodiments” in various places throughout this specification are not necessarily all referring to the same embodiment. Those skilled in the art will recognize that the various embodiments can be practiced without one or more of the specific details or with other methods, components, materials, etc. In other instances, well-known structures, materials, or operations are not shown or not described in detail to avoid obscuring aspects of the embodiments.

Relative terms such as “lower” or “bottom” and “upper” or “top” may be used herein to describe one element's relationship to another element illustrated in the drawings. It will be understood that relative terms are intended to encompass different orientations of aspects of the sleeve and/or the coupled assembly in addition to the orientation depicted in the drawings. By way of example, if aspects of the sleeve shown in the drawings are turned over, elements described as being on the “bottom” side of the other elements would then be oriented on the “top” side of the other elements as shown in the relevant drawing. The term “bottom” can therefore encompass both an orientation of “bottom” and “top” depending on the particular orientation of the drawing.

It must also be noted that as used herein and in the appended claims, the singular forms “a”, “an”, and “the” include the plural reference unless the context clearly dictates otherwise. Thus, for example, reference to a “washer”, or a “fastening means”, is a reference to one or more of each and equivalents thereof known to those skilled in the art, and so forth. More specifically, the term “a washer” should be taken to mean “one or more washers” unless the context clearly dictates otherwise.

Unless defined otherwise, all technical and scientific terms used herein have the same meanings as commonly understood by one of ordinary skill in the art.

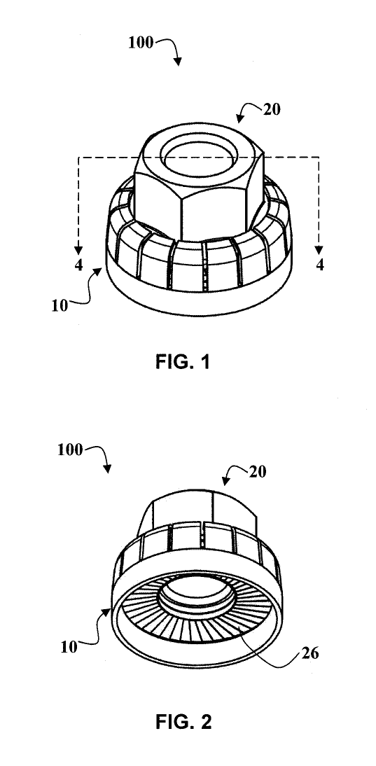

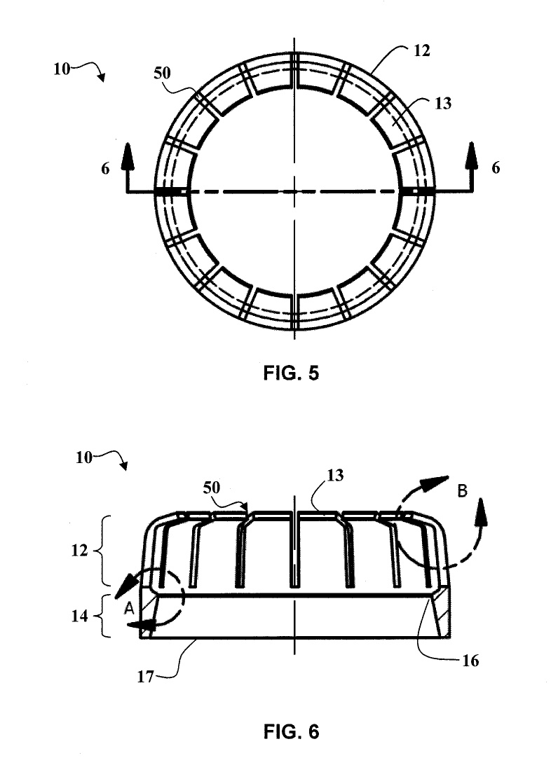

Following is a description of the basic principles and functions of the present invention. Shown in FIGS. 1-4 are illustrations of the fastener assembly 100, comprising a detachable sleeve, generally designated by reference number 10, and a fastening means, generally designated by reference number 20. Shown in FIGS. 5-8 are illustrations of the sleeve 10 according to an embodiment of the present invention.

In the fastener assembly 100 of the present invention, the fastening means 20 and a washer are retained together by the sleeve 10. Upon installation of the fastening means 20 and associated washer on a substrate, the sleeve 10 becomes detached, or is removable from the fastening means 20 and washer.

As shown in FIGS. 1-4, the fastening means 20 may include a nut, such as a flanged hex nut, having a centrally threaded bore 19 configured to accept the shank of a bolt, and a radial flange 24. While shown in use with a specific type of fastening means 20, the sleeve 10 of the present invention may find use with any type of fastening means having a flange and associated washer(s). For example, the sleeve 10 may be useful with a flanged bolt or flanged screw, or any other type of flanged nut known in the art. The sleeve 10 is designed to accommodate a central mounting feature, such as the threaded bore 19 of the nut shown in FIG. 4, or the threaded shank of a bolt or screw. A central longitudinal axis 22 of the sleeve 10 may align with a longitudinal axis of the central mounting feature of the fastening means 20, and with a central bore of the washer (25 and 26).

With continued reference to FIGS. 1-4, the sleeve 10 may encircle or surround an outer perimeter of the fastening means 20 without occluding the central mounting feature, such as the threaded bore 19 of the flanged nut shown, or the top attachment portion 15, such as the hex attachment end of the nut. The sleeve 10 may hold a washer 26, or several washers (25 and 26), in a specific orientation abutting a face on a bottom end 18 of the fastening means 20. Further, the washer (25 and 26) comprises a central bore which may be aligned with the central mounting feature 19 of the fastening means 20.

Alternatively, when the fastening means 20 is a flanged bolt or screw, the central mounting feature of the bolt or screw may comprise a shank which is at least partially threaded. In such case, when encased within the sleeve 10, a head of the bolt or screw, the shank, and the central bore of the washer (25 and 26) remain exposed to allow engagement of the bolt shank or screw shank into a bore hole and/or threaded nut.

According to certain aspects of the present invention, the fastening means 20 may include planar sides which form a polygonal cross section transversely of the central mounting feature, such as the threaded bore 19 in the case of a nut, or the shank in the case of a bolt or screw. The polygonal cross section may be a hexagonal cross-section, as shown for the flanged hex nut in FIGS. 1-4. The fastening means 20 and the washer (25 and 26) may be steel or another suitable material such as acid-resistant steel. The fastening means 20 and the washer (25 and 26) may be coated or uncoated.

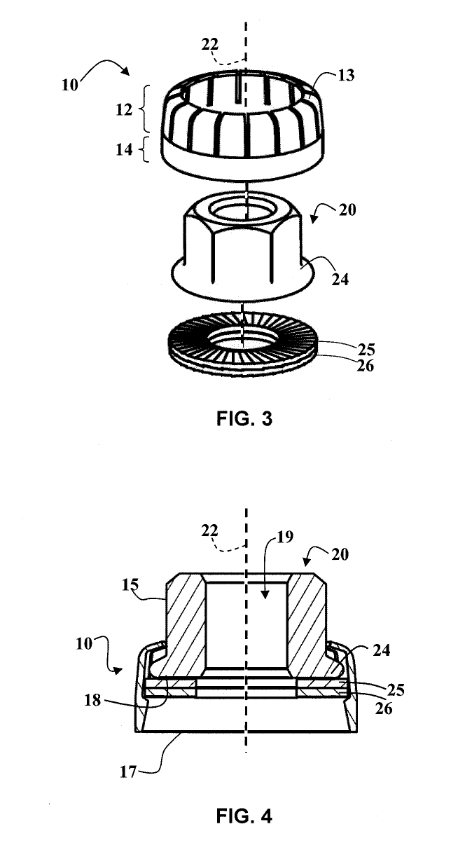

While the washers (25 and 26) are shown in FIGS. 2 and 3 to include a specific arrangement of cams, the washers may include more or fewer cams having larger or smaller profiles. For example, a pair of washers may have one side with cams and one principally flat side, wherein the washer sides with cams may be arranged facing each other. In such a case, the principally flat upper side of the upper washer of the pair may be arranged against a principally flat bottom side of the flanged nut. In this case, the sleeve 10 maintains the washers in a specific arrangement with the fastening means 20 and ensures proper installation of the combination. Alternatively, the washers (25 and 26) may have substantially smooth surfaces, and arrangement of the washers within the sleeve may not be specifically critical. In such a case, the sleeve 10 still maintains the washers (25 and 26) in connection with the fastening means 20 so that all of the components are properly installed on a substrate. Further, while a pair of washers (25 and 26) is shown in FIGS. 1-4, any number of washers may be included in the fastener assembly 100, and may be encased within the sleeve 10, of the present invention.

The sleeve 10 may be removable from the fastener assembly 100 after the fastening means 20 and the washer (25 and 26) have been engaged: in the case of a nut, with a threaded bolt element; in the case of a bolt or screw, with a bore hole and/or threaded nut. In certain instances, the sleeve 10 may become detached and be released from the fastener assembly 100 after the fastening means 20 and the washer (25 and 26) have been such engaged without further intervention.

Turning now to FIGS. 5-8, the sleeve 10 generally comprises a main body which includes a top portion 12 that is angled radially inward at a top end thereof to form a ridge 13, and a bottom portion 14 which includes an annular lip 16 that extends radially inward from an inner surface of the main body. The top portion 12 may be defined by the region between a top end of the main body, which includes the ridge 13, and the annular lip 16. The bottom portion 14 may be defined by the region between the annular lip 16 and a bottom end 17 of the main body.

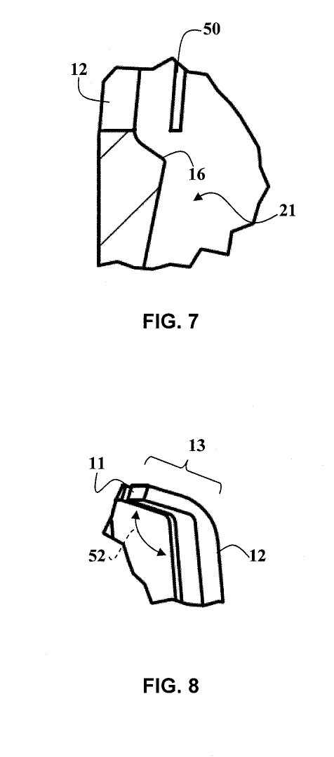

The ridge 13 of the top portion 12 is configured to rest against a flange 24 of the fastening means 20. With reference to FIG. 8, the top portion 12 may be angled 52 proximal to a top end 11 thereof to form the ridge 13. The angle 52 and length of the ridge 13 (distance from the end 11 of the top portion 12 at which the angle in induced) may be varied to accommodate various fastener means designs (e.g., thickness and diameter of the flange 24 on the fastener means 20). With reference to FIG. 7, the annular lip 16 of the bottom portion 14 extends radially inward from an inner surface 21 of the main body, and is configured to retain the washer (25 and 26) in abutting relation to the face on the bottom end 18 of the fastening means 20.

The top portion 12 of the sleeve 10 is generally configured to be flexible so that installation of the fastener assembly 100 causes the top portion 12 to radially expand and/or longitudinally contract, and thus allows a longitudinal distance (length) of the sleeve 10 to be shortened and/or a radial diameter of the top end 11 of the sleeve 10 to be increased. That is, at least the top portion 12 of the sleeve may be shortened and/or at least the top end 11 of the sleeve, including the ridge 13, may be radially expanded. As such, upon installation of the fastening means 20 on a substrate, the sleeve 10 may expand and/or compress so that an installation tool maintains full contact with the fastening means 20. After installation, the sleeve 10 may be removable, or may become detached from the fastening means 20 and the washer (25 and 26).

The sleeve 10 may be formed of a polymeric material, such as a flexible plastic material. Non-limiting examples of such materials include at least polypropylene and polyethylene. In general, the functionality of the sleeve 10 relies on the sleeve to be rigid enough to manage coupling the various fastening components together for packaging, shipping and consequently assembly. Upon installation, however, the sleeve may be flexible enough to release from the fastening components. Such removal or detachment of the sleeve may facilitate installation of the fastening components. The determination of this combination of rigid and flexible is one basis for the novel design of the present invention.

In particular, according to certain aspects of the present invention, the top portion 12 of the sleeve 10 may be formed of a flexible polymeric material. In certain instances, the top portion 12 of the sleeve 10 may be formed of a resilient polymeric material such as, for example, a rubber or silicone type material, so that the top portion may be compressed by the installation action. Alternatively, or in addition, the top portion 12 may comprise a plurality of serrated fingers or fins separated by openings 50, wherein the fingers are angled at a top end to form the ridge 13. The plurality of serrated fingers may be formed of a flexible polymeric material and may be configured to provide the radial expansion and/or longitudinal contraction of the sleeve at the top portion thereof.

The sleeve further comprises a bottom portion 14 (ejector end discussed below). As shown in FIG. 4, which illustrates a cross-sectional view taken along line 4-4 from FIG. 1, and in FIG. 6, which illustrates a cross-sectional view taken along line 6-6 from FIG. 5, the sleeve 10 may comprise an annular lip 16 on the inside diameter which provides the corresponding method of retention on the underside of the washer. This annular lip 16 may have a profile and size designed to ensure retention of the washer 25 within the sleeve 10 and abutted against the lower end 18 (face) of the fastening means 20.

Overall, the diameter of the sleeve 10 may be sized to accommodate a diameter of the fastening means 20 and the washer (25 and 26), and may include a tolerance variation. The tolerance variation provides free movement of the sleeve 10 about the combination of fastening means 20 and washer.

The height of the top portion 12 of the sleeve 10, defined by a distance between the ridge 13 and the annular lip 16, may be sized to accommodate the thickness of a standard flange 24 of the fastening means 20 and the washer (25 and 26), and may also include a tolerance variation. The tolerance variation may allow for variations in the thickness of the flange 24 of the fastening means 20 and/the washer (25 and 26). Ultimately, this profile enables assembly of the fastener means 20 and the one or more washers within the sleeve 10, and consequently the disengagement of the sleeve 10 upon the final installation by the end user.

Thus, the sleeve 10 of the present invention may be designed and configured to accommodate various flange 24 thicknesses, various numbers of washers and washer thicknesses, and various diameters of each of the aforementioned.

During the installation of the fastener assembly 100, the sleeve 10 becomes disengaged from the fastening means 20 and washer (25 and 26). The fastening means 20 will draw onto the receiving end of the faster: bolt/stud in cases where the fastening means is a nut; tapered hole/nut in cases when the fastening means is a bolt/screw. Pressure from the installation equipment (e.g., screw driver or drive socket) may cause the serrated fingers 12 to deform, or compress, thus enabling the installation equipment to remain in contact with the fastening means 20. At the same time, the sleeve 10 will bottom out on the base material and begin to disengage. The ejector end (bottom end 14) of the sleeve 10 thus enables the annular lip 16 to disengage from the one or more washers and begin the separation process.

A height of the bottom portion 14, defined by the distance between the annular lip 16 and the bottom end 17 of the main body, may be configured to cause release of the sleeve 10 from the fastening means 20 and washer. For example, the height of the bottom end 14 may be slightly greater than a thickness of the washer (25 and 26), so that this region may act as an ejector end which forces the sleeve 10 to detach from the fastening means 20 and the washer (25 and 26) upon installation of the fastening means 20 on a substrate.

The present invention also provides a method of manufacturing a fastener assembly 100. The method comprises the steps of: (a) providing a fastening means, a washer, and a sleeve as disclosed hereinabove; (b) arranging the fastening means and the washer within the sleeve such that a ridge of the sleeve rests against a flange of the fastening means, and an annular lip of the sleeve retains the washer in abutting relation to the face of the fastening means. The main body of the sleeve may be configured to surround an outer surface of each of the washer and the fastening means. This manufacturing process may be completed manually, or by mechanized equipment.

### EXAMPLES

The overall design and function of the sleeve 10 was validated through multiple mock installation exercises. A specific sleeve design was produced as configured and shown in 5-8, with the dimensions designed to encase an M14 flanged hex nut (i.e., 14 mm diameter nut) and a pair of associated washers for testing purposes.

The following tools were used during the validation testing process: (1) Stud fixture & Vice: Stud with an M14 thread and reaction face for a washer, and a vice were used to keep the stud stationary during test; (2) A 21 mm deep well Proto impact socket; (3) A ½ Drive Genius Torque Stick (Part Number 487140) limited to 140 ft-lbs (190 Nm); and (4) A Dewalt cordless ½″ impact—Part Number 951362. The sleeve as shown in FIGS. 5 to 8 was used to enclose an M14 Nyloc Flange Nut and a pair of cammed washers. The test sleeves were manufactured via plastic injection molding using a polypropylene plastic.

The following product validation test procedure was performed to show proper installation of the assembly of the combination fastening means, washer(s), and sleeve, and to test sleeve disengagement:
1. The stud fixture was mounted in the vice.
2. The fastening means and washer(s) were assembled into sleeves to form fastener assemblies (20 total: M14 Nyloc Flange Nut with washer pair assembled into test sleeves).
3. The torque stick and socket were attached to the Dewalt cordless ½″ impact. The torque stick provided a consistent torque to the fastener assembly (sleeve, nut, washer).
4. Each fastener assembly was threaded onto the test stud, only 1 or 2 threads to ensure the product was started onto the stud.
5. Using the Dewalt cordless ½″ impact, with socket and torque stick, the fastener assembly was torqued onto the test stud.
6. The impact was removed from the M14 Nyloc Flange Nut.
7. The sleeve is removed from the Flange Nut by hand, with ease.
8. Repeat steps 4 thru 7 for all combination product assemblies.

Results: The validation tests of the washer coupled with the flanged hex nut showed that assembly of the fastener assembly (sleeve, nut, and washer) could be achieved rapidly and with ease, and that installation of the fastener assembly was straightforward. The washer pair remained captive and properly aligned with the M14 Nyloc flange nut within the sleeve prior to and during installation. All (20) sleeves tested were removed by hand with ease after installation was completed.

Each of the characteristics and exemplary embodiments described above, and combinations thereof, may be said to be encompassed by the present invention. The present invention is thus drawn to the following non-limiting aspects:

(1) A sleeve for retaining a washer in abutting relation to a face of a fastening means, the sleeve comprising a main body which includes: a top portion which is angled at a top end to form a ridge; and a bottom portion defined by a bottom end of the main body and an annular lip that extends radially inward from an inner surface of the main body and is positioned at a distance from the bottom end of the main body, wherein the ridge of the top portion is configured to rest against a flange of the fastening means, and the annular lip of the bottom portion is configured to removeably retain the washer in abutting relation to the face of the fastening means.

(2) The sleeve according to aspect 1, wherein a height of the bottom portion, defined by the distance between the annular lip and the bottom end of the main body, is greater than a thickness of the washer.

(3) The sleeve according to any of aspects 1 or 2, wherein a height of the top portion, defined by a distance between the ridge and the annular lip, is greater than a thickness of the flange of the fastening means and the washer, so that the sleeve holds the washer abutting the face of the fastening means and permits free relative rotation therebetween.

(4) The sleeve according to any of aspects 1 to 3, wherein the top portion of the main body comprises a plurality of serrated fingers which provide radial expansion or contraction of the sleeve at the top portion thereof.

(5) The sleeve according to any of aspects 1 to 4, wherein the sleeve is formed of a flexible polymeric material.

(6) The sleeve according to any of aspects 1 to 5, wherein the sleeve is removable from the fastening means and the washer after the fastening means and washer have been installed.

(7) The sleeve according to any of aspects 1 to 6, wherein the sleeve becomes detached from the fastening means and the washer after the fastening means and washer have been installed.

(8) A fastener assembly comprising: a fastening means having a face and a central mounting feature intersecting the face; a washer abutting the face of the fastening means, the washer having a central bore aligned with the central mounting feature of the fastening means; and the sleeve according to any of aspects 1 to 7, wherein the sleeve is removeably attachable about the fastening means and the washer.

(9) The fastener assembly according to aspect 8, wherein the fastening means is a screw or bolt and the central mounting feature is a threaded shank thereof.

(10) The fastener assembly according to any of aspects 8 or 9, wherein the fastening means is a nut and the central mounting feature is a threaded bore designed to receive a threaded bolt element.

(11) The fastener assembly according to any of aspects 8 to 10, wherein the sleeve is configured to loosely hold the washer abutting the face of the fastening means to permit free relative rotation therebetween.

(12) A method of manufacturing a fastener assembly, the method comprising the steps of: (a) providing components of the fastener assembly according to any of aspects 8 to 10; and (b) arranging the fastening means and the washer within the sleeve such that the ridge of the sleeve rests against a flange on the fastening means, and the annular lip of the sleeve retains the washer in abutting relation to the face of the fastening means with the central bore of the washer aligned with the central mounting feature of the fastening means, and permits free relative rotation therebetween, wherein the main body of the sleeve partially surrounds an outer surface of each of the washer and the fastening means, and wherein the fastening means and the washer are removeably retained within the sleeve.

While specific embodiments of the invention have been described in detail, it should be appreciated by those skilled in the art that various modifications and alternations and applications could be developed in light of the overall teachings of the disclosure. Accordingly, the particular arrangements, systems, apparatuses, and methods disclosed are meant to be illustrative only and not limiting as to the scope of the invention.

What is claimed is:

1. A fastener assembly comprising:
a fastening means having a face and a central mounting feature intersecting the face;
a washer abutting the face of the fastening means, the washer having a central bore aligned with the central mounting feature of the fastening means; and
a sleeve formed of a polymeric material, wherein the sleeve is removeably attachable about the fastening means and the washer, the sleeve comprising a main body portion which includes:
a top portion which is angled at a top end to form a ridge, wherein the ridge rests against a flange of the fastening means, and
a bottom portion defined by a bottom end of the main body and an annular lip that extends radially inward from an inner surface of the main body and is positioned at a distance from the bottom end of the main body,
wherein the main body of the sleeve partially surrounds an outer surface of each of the washer and the fastening means, and the ridge and annular lip of the sleeve retain the washer in abutting relation to the face of the fastening means.

2. The fastener assembly of claim 1, wherein the top portion of the main body of the sleeve comprises a plurality of serrated fingers which provide radial expansion or contraction of the sleeve at the top portion thereof.

3. The fastener assembly of claim 1, wherein a height of the bottom portion of the sleeve, defined by the distance between the annular lip and the bottom end of the main body, is greater than a thickness of the washer.

4. The fastener assembly of claim 1, wherein the fastening means is a screw or bolt and the central mounting feature is a threaded shank thereof.

5. The fastener assembly of claim 1, wherein the fastening means is a nut and the central mounting feature is a threaded bore designed to receive a threaded bolt element.

6. The fastener assembly of claim 1, wherein the sleeve is configured to loosely hold the washer abutting the face of the fastening means to permit free relative rotation therebetween.

7. The fastener assembly of claim 1, wherein the sleeve is removable from the fastener assembly after the fastening means and the washer are engaged with a receiving element.

8. The fastener assembly of claim 1, wherein the sleeve becomes detached from the fastener assembly after the fastening means and the washer are engaged with a receiving element.

9. A method of manufacturing a fastener assembly, the method comprising the steps of:
(a) providing components of a fastener assembly comprising:
a fastening means having a face and a central mounting feature intersecting the face,
a washer having a central bore, and
a sleeve formed of a polymeric material, the sleeve comprising a main body portion which includes:
a top portion which is angled at a top end to form a ridge, and
a bottom portion defined by a bottom end of the main body and an annular lip that extends radially inward from an inner surface of the main body and is positioned at a distance from the bottom end of the main body; and
(b) arranging the fastening means and the washer within the sleeve such that the ridge of the sleeve rests against a flange on the fastening means, and the annular lip of the sleeve retains the washer in abutting relation to the face of the fastening means with the central bore of the washer aligned with the central mounting feature of the fastening means, and permits free relative rotation therebetween,
wherein the main body of the sleeve partially surrounds an outer surface of each of the washer and the fastening means, and wherein the fastening means and the washer are removeably retained within the sleeve.

10. The method of manufacturing of claim 9, wherein the top portion of the main body of the sleeve comprises a plurality of serrated fingers which provide radial expansion or contraction of the sleeve at the top portion thereof.

11. The method of manufacturing of claim 9, wherein a height of the bottom portion of the sleeve, defined by the distance between the annular lip and the bottom end of the main body, is greater than a thickness of the washer.

12. The method of manufacturing of claim 9, wherein the fastening means is a screw or bolt and the central mounting feature is a threaded shank thereof.

13. The method of manufacturing of claim 9, wherein the fastening means is a nut and the central mounting feature is a threaded bore designed to receive a threaded bolt element.

14. A sleeve for retaining a washer in abutting relation to a face of a fastening means, the sleeve comprising a main body which includes:
a top portion which is angled at a top end to form a ridge; and
a bottom portion defined by a bottom end of the main body and an annular lip that extends radially inward from an inner surface of the main body and is positioned at a distance from the bottom end of the main body,
wherein the ridge of the top portion is configured to rest against a flange of the fastening means, and the annular lip of the bottom portion is configured to removeably retain the washer in abutting relation to the face of the fastening means.

15. The sleeve of claim 14, wherein a height of the bottom portion, defined by the distance between the annular lip and the bottom end of the main body, is greater than a thickness of the washer.

16. The sleeve of claim 14, wherein a height of the top portion, defined by a distance between the ridge and the annular lip, is greater than a thickness of the flange of the fastening means and the washer, so that the sleeve holds the washer abutting the face of the fastening means and permits free relative rotation therebetween.

17. The sleeve of claim 14, wherein the top portion of the main body comprises a plurality of serrated fingers which provide radial expansion or contraction of the sleeve at the top portion thereof.

18. The sleeve of claim 14, wherein the sleeve is formed of a flexible polymeric material.

19. The sleeve of claim 14, wherein the sleeve is removable from the fastening means and the washer after the fastening means and washer have been installed.

20. The sleeve of claim 14, wherein the sleeve becomes detached from the fastening means and the washer after the fastening means and washer have been installed.
